(19) United States
(12) Patent Application Publication
(10) Pub. No.: US 2017/0002438 A1
(43) Pub. Date: Jan. 5, 2017

(54) CONTINUOUS PROCESSING LINE FOR PROCESSING A NON-MAGNETIC METAL STRIP INCLUDING A GALVANNEALING SECTION AND METHOD FOR INDUCTION HEATING OF SAID STRIP IN SAID GALVANNEALING SECTION

(71) Applicant: FIVES CELES, Lautenbach (FR)

(72) Inventor: Emmanuel PATARD, Lautenbach (FR)

(21) Appl. No.: 15/101,536

(22) PCT Filed: Dec. 8, 2014
(86) PCT No.: PCT/IB2014/066694

§ 371 Date: Jun. 3, 2016

(30) Foreign Application Priority Data
Dec. 6, 2013 (FR) 13 62272

(51) Int. Cl. C21D 9/60; C23C 2/40; H05B 6/44; F27D 11/06; H05B 6/10; C23C 2/00; C23C 2/28

(52) U.S. Cl. CPC C21D 9/60; C23C 2/003; C23C 2/40; C23C 2/285; F27D 11/06; H05B 6/104; H05B 6/44; C21D 2251/02; F27D 2099/0015

(57) ABSTRACT

Disclosed is a continuous processing line for processing a non-magnetic metal strip 1 and specifically to an induction heating apparatus 14 and method intended for heating the non-magnetic metal strip travelling through the continuous processing line, including a coating section 20, the apparatus being installed downstream from the coating section in the direction of travel of the strip, the apparatus making it possible to raise the temperature of the strip across the entire width thereof to the level required to obtain the sought development of the coating thereof, the heating apparatus including at least one cross-flow inductor 15.

The invention concerns lines for continuous galvanization of steel coils, and more particularly to the galvannealing section. It relates in particular to an apparatus and a method for heating the strip by transverse flux induction with a view to heating grades of nonmagnetic steels during the galvannealing process.

The demand for galvanized steel with high mechanical performance is increasing greatly worldwide. This is true particularly in the automobile sector in which the use of these steels makes it possible to reduce the thickness of the sheet metal with the same mechanical strength. The weight saving which results from the thickness reduction leads to a lower fuel consumption of the vehicles and therefore to less CO₂ emission. Steels with a high manganese content are particularly advantageous because they combine high mechanical strength and a high capacity for shaping by drawing.

The sheet metal used for the bodywork of automobiles is often coated by the galvannealing method. In this method, a step is added after the hot-dip galvanization of the strip. It consists in heating the galvanized steel strip at the exit of the zinc bath, followed by a holding phase. In this step, the layer of zinc becomes modified by the diffusion of iron of the sheet metal and zinc of the coating, which leads to the creation of an alloy between the metal support and the layer of zinc. The galvannealing increases the weldability of the coated sheet metal and improves the surface quality of the sheet metal after painting.

It is to be noted here that the term galvannealing is not similar to an anneal which is carried out at a higher temperature, around 800° C., while galvannealing is for its part carried out at a lower temperature, below 650° C. This is a heating and holding treatment, which could be referred to as an “alloying treatment” (alloying as in the creation of an alloy between the galvanization layer and its support). Reference may be made to paragraph 2.3.7.2 of document m1531 of the “Techniques de l'ingénieur” [Techniques of the engineer], which explains the galvannealing method by using an example. It states that when the sheet metal leaves the galvanization tank toward 450° C., by rapidly raising this temperature to 500° C. then keeping the strip at this temperature, for example for 10 seconds, the zinc coating is converted into an iron/zinc alloy by diffusion of iron into the liquid zinc, and the coating obtained then has a matt gray coloration and contains from 8 to 12% iron. This treatment is carried out in a vertical furnace arranged immediately after the tank along the upward path of the cooling tower.

The heating of the strip in a galvannealing section is traditionally carried out by longitudinal flux induction heating equipment. It has the advantage of transmitting a high power density to the strip, thus making it possible to reduce the length of the equipment. This is because the compactness of the heating equipment is crucial in the galvanization tower, since the addition of a galvannealing step leads to a significant increase in the height of the tower due to the length of the equipment to be installed in order to carry out the heating and holding of the strip at the temperature, as well as the additional cooling of the latter. Specifically, the coating of the strip needs to be solidified before reaching the deflector roll placed at the top of the tower in order to avoid marking the surface of the strip. The length of the holding equipment is defined by the time needed to carry out the diffusion of the metals. Since the heat input needed for maintaining the temperature of the strip is limited, the heating of the strip is generally carried out using electrical resistors.

At the entry of the galvannealing section, the edges of the strip are cooler. This is because, in addition to greater natural cooling on the sides, the air blown in by the drying machine in order to remove the excess zinc from the strip leads to greater cooling of the edges. During the holding of the strip at temperature, which follows its heating to the temperature required for the galvannealing, it is advantageous for the temperature of the strip to be homogeneous over its width, so that the diffusion of iron into the liquid zinc is the same over the entire width of the strip, and in particular on the edges. In order to compensate for a lower temperature of the edges at the entry of the galvannealing section, it is therefore necessary to overheat them. To this end, FR2661423 describes the addition of edge heating devices. This solution is not fully satisfactory because it requires the installation of additional equipment in order to overcome this problem.

Galvannealing is not used for all grades of galvanized sheet metal. It is necessary to take the galvannealing equipment offline when it is not being used in order to replace it with cooling sleeves making it possible to increase the cooling capacity of the tower and thus the production capacity of the line in terms of galvanized steel (GI). By its principle, longitudinal flux induction heating equipment comprises a coil which encloses the strip. In order to take the heating equipment offline, it is necessary to provide an inductor which can be opened. The complexity of such equipment, described for example by JP2903449, makes this solution unattractive.

Steels with a high manganese content generally have an austenitic structure at room temperature and are nonmagnetic. Longitudinal flux induction heating is no longer possible for these steels because of the very low heating efficiency. There is thus to date no device for induction heating in the galvannealing sections for coating nonmagnetic steels. The solution of the prior art consists in installing equipment fitted with burners or electrical resistors, but it leads to an excessive length of the equipment as a result of limited power densities.

The invention provides a solution to the problems mentioned above, which is particularly advantageous for the galvannealing of nonmagnetic steels, while making it possible to have a heating section which is very compact, can be taken offline easily and makes it possible to overheat the edges.

According to a first aspect, the invention thus relates to a continuous processing line for processing a nonmagnetic metal strip, the processing line comprising a coating section and a galvannealing section placed downstream of the coating section and comprising an induction heating apparatus intended to heat said nonmagnetic metal strip, the apparatus making it possible to raise the temperature of the strip to the level required in order to obtain the desired modification of its coating, characterized in that the heating apparatus comprises at least one transverse flux inductor.

This is a new application of transverse flux induction in a continuous line, this having been envisaged by the person skilled in the art only for sections for annealing at high temperature, generally above 800° C., said annealing sections making it possible to modify the metallurgical structure of the strip at depth. With a transverse flux inductor, the magnetic flux is directed perpendicularly to the surface of the strip. In contrast, during longitudinal flux heating the magnetic flux is tangent to the surface of the strip. In the scope of the invention, transverse flux induction makes it possible to heat nonmagnetic materials with a very good energy efficiency and high power densities.

In practice, the transverse flux inductor is composed of two magnetic pole structures located on either side of the strip to be heated, with excitation coils. The polarity of the alternating current in the coils is that, at any time, the mutually opposing magnetic poles have opposite signs, which compels the magnetic flux to pass through the strip.

The use of a transverse flux inductor for heating the strip in a galvannealing section is made complex because of the need to obtain an optimal heating quality for different strip widths. Thus, the apparatus according to the invention has coils whose dimensions are adapted so as to influence the transverse temperature profile of the strip. According to one alternative embodiment of the invention, the apparatus comprises screens which can be moved laterally over the width of the strip with a view to influencing the transverse temperature profile of the strip, so that adjustment of the position of the screens makes it possible to regulate overheating of the edges of the strip. The screens may also be movable transversely in order to adjust their spacing with respect to the strip. The transverse flux inductor generally comprises two pairs of coils. The choice of the number of pairs of coils will depend, in particular, on the characteristics of the strip to be heated and on the production capacity of the line.

The transverse flux inductor according to the invention has a design with two plates which are located independently on either side of the steel strip and are not connected mechanically. It allows easy retraction or withdrawal of the galvannealing section when it is not being used, thus freeing up space which may be used for other purposes when the galvanization line is not producing galvannealed steel (GA).

According to a second aspect, the invention also relates to an induction heating method intended for heating a nonmagnetic metal strip in a galvannealing section of a continuous processing line for processing said nonmagnetic metal strip, said processing line comprising a coating section, the galvannealing section being placed downstream of the coating section, characterized in that the heating of the strip is carried out by means of a transverse flux inductor.

Thus, the coating section of the line allows hot-dip galvanization and the heating according to the invention makes it possible to carry out galvannealing.

According to the invention, in order to anticipate the additional cooling of the edges which results from the side effect in the drying machine, the edges of the strip are directly overheated by the transverse flux inductor in order to obtain a substantially homogeneous strip temperature over its width during the temperature holding phase of the galvannealing.

The control, specific to galvannealing, of the screens of the transverse flux inductor according to the invention makes it possible not only to obtain a flat temperature profile at the exit of the inductor when the profile of the entry of the inductor is flat, but also to obtain a flat profile at the exit of the inductor when the temperature profile exhibits local edge underheating, which is the typical case of profiles at the exit of galvanization sections. Controlling the position of the screens thus makes it possible to compensate for the edge underheating at the exit of the galvanization section and to obtain a flat temperature profile for different galvanized steel strip widths by virtue of expedient positioning of movable screens.

The characteristics and advantages of the invention will become apparent on reading the following description, which is given by way of nonlimiting example and with reference to the following appended figures:

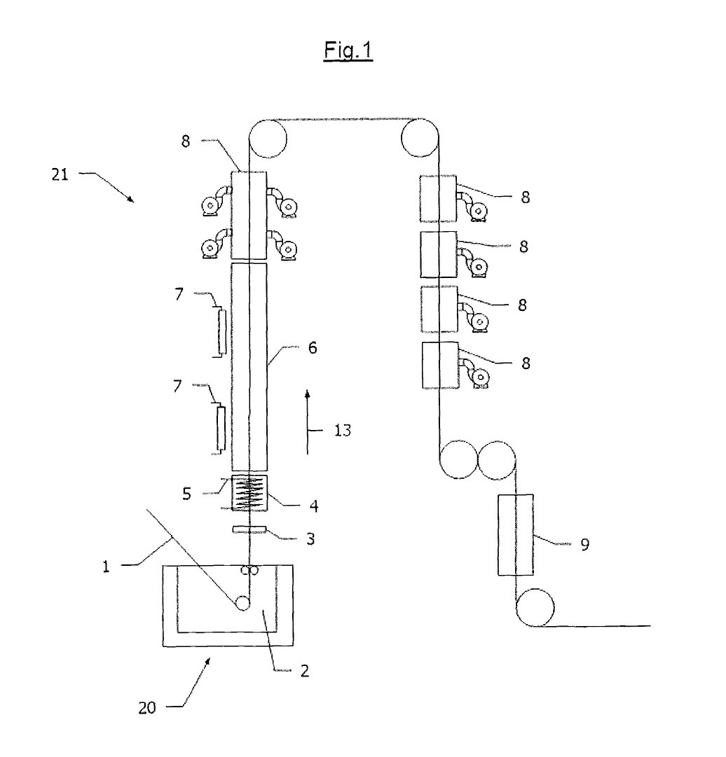

FIG. 1: schematically represents a coating section of a galvanization line for processing magnetic steels, comprising galvannealing with longitudinal flux induction heating according to the prior art,

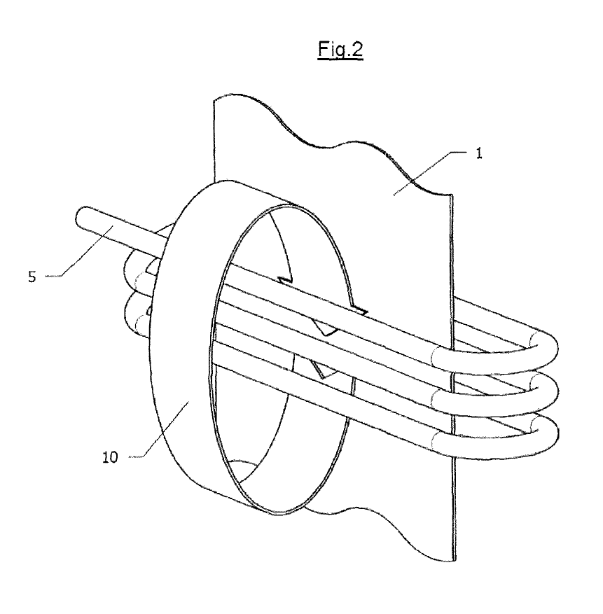

FIG. 2: schematically illustrates the magnetic flux which results from a longitudinal flux inductor,

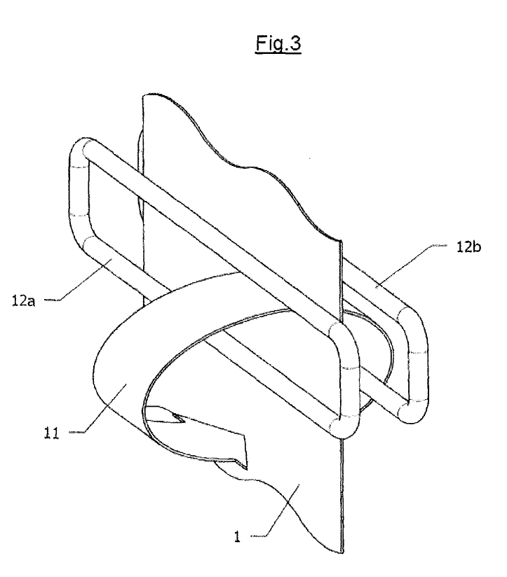

FIG. 3: schematically illustrates the magnetic flux which results from a transverse flux inductor,

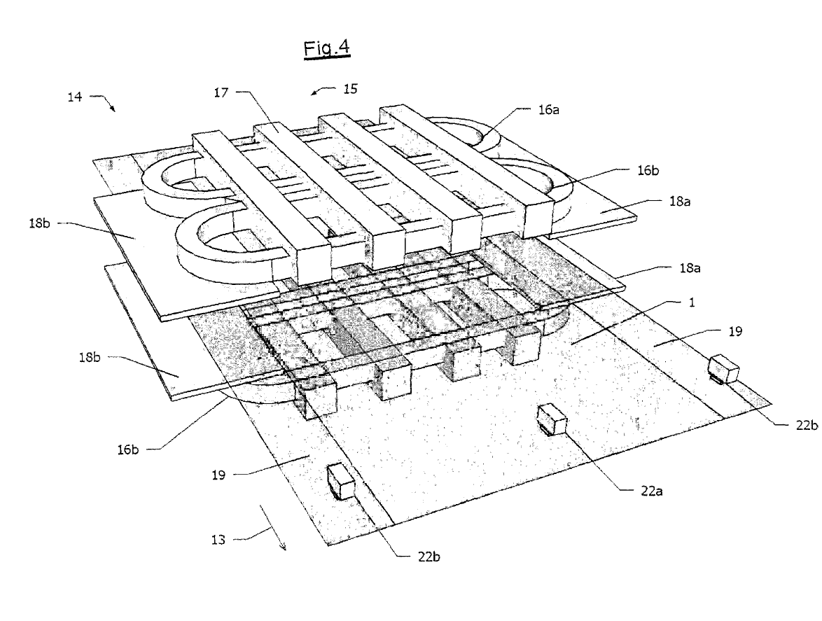

FIG. 4: schematically represents an exemplary embodiment of an induction heating apparatus according to the invention, and

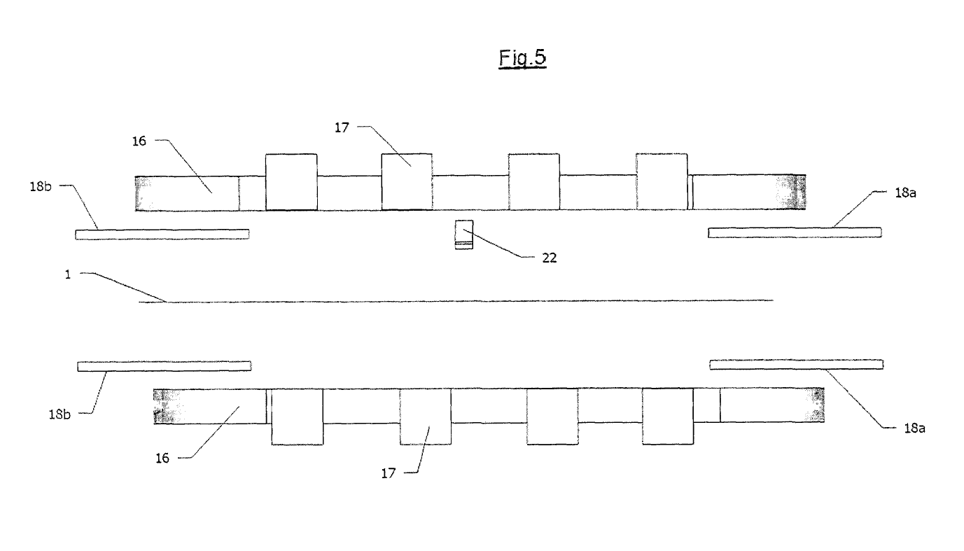

FIG. 5: schematically represents a sectional view of an exemplary embodiment of an induction heating apparatus according to the invention, showing in particular the use of movable screens.

FIG. 1 schematically represents a galvanization tower 21 of a galvanization line. A galvannealing section is placed downstream of the coating section 20. The strip 1 coming from the annealing furnace is immersed in the zinc bath 2. The direction of advance of the strip is indicated by the arrow 13. At the exit of the zinc bath, the strip rises vertically in the galvanization tower. It passes through a dryer 3 which makes it possible to keep on the strip only the required coating thickness before entering the galvannealing section.

The strip passes first through the heating apparatus 4 equipped with a longitudinal flux inductor 5, which makes it possible to bring the strip to the temperature required for the galvannealing. It then passes through the holding unit 6 equipped with electrical resistors 7. The strip is then cooled with air by successive cooling sleeves 8 then with water in a water tank 9.

FIG. 2 schematically illustrates the magnetic flux 10 which results from a longitudinal flux inductor 5. This flux is tangent to the surface of the strip 1.

FIG. 3 schematically illustrates the magnetic flux 11 which results from a transverse flux inductor 12. This inductor consists of a pair of coils 12a, 12b. The flux is directed perpendicularly to the surface of the strip 1.

FIG. 4 schematically represents an exemplary embodiment of an induction heating apparatus 14 according to the invention. This apparatus comprises a transverse flux inductor 15 comprising two pairs of coils 16a, 16b, which follow one another in the direction of advance of the strip. One pair consists of coils placed on each side of the strip 1. The coils are held by supports 17.

The apparatus also comprises screens 18 placed on either side of the edges 19 of the strip. FIG. 5 illustrates in more detail the positioning of these movable screens 18a, 18b with respect to the strip 1, to the coils 16 and to the support plates 17.

These screens can be removed laterally over the width of the strip so as to influence the transverse temperature profile of the strip. Lateral adjustment is intended to mean that 2 screens 18a, 18b placed on the two opposite edges 19 of the strip are moved closer together or further away. Adjustment of the position of the screens makes it possible to regulate overheating of the edges in order to compensate for the side effects which have led to greater cooling of the edges and thus to obtain a substantially homogeneous temperature of the strip at the exit of the inductor.

According to one alternative embodiment of the invention, the screens 18 can also be moved transversely in order to adjust their spacing with respect to the strip. This complementary adjustment allows a further possibility of regulating the heating apparatus.

Controlling the screens thus makes it possible to correct an insufficient temperature of the edges existing before the galvannealing section, and to do so for sheet metal of different widths, in which the position and the width of the underheating can vary along the width and thickness of the steel strips to be treated.

According to one exemplary embodiment of the invention, which is represented in FIG. 4, the control of the transverse flux inductor is carried out on the basis of a temperature measurement of the strip by a contactless temperature measurement system 22 with a panoramic view, covering the entire width of the strip, or one composed of several contactless measurement systems over the width of the strip, for example one system 22a located on the center of the strip and two systems 22b located on its edges.

Advantageously according to the invention, the position of the strip with respect to the theoretical axis of the line, and its possible drift with respect to the center of the line, is monitored by the system/systems for measuring the temperature at the edges, by carrying out actual detection of the position of the edges, which is obtained by the difference between the temperature of said edges and of the bottom of the furnace. If necessary, the position of the inductor is adjusted in order to maintain optimum heating of the strip even in the event of a drift thereof with respect to the center of the line.

Furthermore, the overall temperature level of the strip at the exit of the inductor is adjusted with a minimum difference from the average temperature imposed by the method by using the system 22 for measuring the temperature of the strip, while considering only the central part of the strip, or an average temperature after excluding the temperature of the edges.

1. A continuous processing line for processing a nonmagnetic metal strip (1), the processing line comprising a coating section (20) and a galvannealing section placed downstream of the coating section (20) and comprising an induction heating apparatus (14) intended to heat said nonmagnetic metal strip, characterized in that the heating apparatus comprises at least one transverse flux inductor (15).

2. The processing line as claimed in claim 1, comprising screens (18) which can be moved laterally over the strip width so as to influence the transverse temperature profile of the strip, characterized in that adjustment of the position of the screens makes it possible to regulate overheating of the edges (19) of the strip.

3. The processing line as claimed in claim 2, characterized in that the screens (18) can be moved transversely in order to adjust their spacing with respect to the strip.

4. The processing line as claimed in claim 1, characterized in that the transverse flux inductor (15) comprises at least two pairs of coils (16).

5. A method for induction heating of a nonmagnetic metal strip (1) in a galvannealing section of a continuous processing line for processing said nonmagnetic metal strip, said processing line comprising a coating section (20), the galvannealing section being placed downstream of the coating section, characterized in that the heating of the strip is carried out by means of a transverse flux inductor (15).

6. The method as claimed in claim 5, characterized in that the position of movable screens (18) is adjusted so as to regulate overheating of the edges of the nonmagnetic metal strip (1) by the transverse flux inductor (15) and to obtain a substantially homogeneous temperature of the strip at the exit of the inductor.
